(19) United States
(12) Patent Application Publication
(10) Pub. No.: US 2026/0291646 A1
(43) Pub. Date: Sep. 24, 2026

(54) PRECODER DESIGN FOR MINIMIZING THE IMPACT OF HYBRID TIME AND FREQUENCY-DOMAIN CYCLIC SHIFT-CODED PORT VIRTUALIZATION ON COMMUNICATION PERFORMANCE

(71) Applicant: MEDIATEK INC., Hsinchu City (TW)

(72) Inventors: Jiaying REN, San Jose, CA (US); Shiauhe Shawn TSAI, San Jose, CA (US)

(73) Assignee: MEDIATEK INC., Hsinchu City (TW)

(21) Appl. No.: 19/472,780

(22) PCT Filed: Nov. 26, 2024
(86) PCT No.: PCT/CN2024/134401

§ 371 Date: Oct. 6, 2025

Related U.S. Application Data
(60) Provisional application No. 63/608,893, filed on Dec. 12, 2023.

(51) Int. Cl. H04L 1/00; H04W 72/044

(52) U.S. Cl. CPC H04L 1/0061; H04W 72/044

(57) ABSTRACT

In an aspect of the disclosure, a method, a computer-readable medium, and an apparatus are provided. The method generates a cyclic shift code for data of a transmit antenna set, the cyclic shift code including cyclic shifts of at least two dimensions, and a precoder configured based on a predetermined design principle. The method generates an antenna transmission signal using the cyclic shift code.

### CROSS-REFERENCE TO RELATED APPLICATION(S)

This application claims the benefits of U.S. Provisional Application Ser. No. 63/608,893, entitled “Method of precoder design for minimizing the impact of hybrid time and frequency-domain cyclic shift-coded port virtualization on communication performance in joint communication and sensing system” and filed on Dec. 12, 2023, which is expressly incorporated by reference herein in its entirety.

### TECHNICAL FIELD

The present disclosure relates generally to wireless communications, and more particularly, to the precoder design for minimizing the impact of hybrid time and frequency-domain cyclic shift-coded port virtualization on communication performance in an integrated sensing and communication and system (ISAC).

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method generates a cyclic shift code for data of a transmit antenna, the cyclic shift code including cyclic shifts of at least two dimensions, and a precoder configured based on a predetermined design principle. The method generates an antenna transmission signal using the cyclic shift code.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example architecture of an ISAC system.

FIG. 8 is a diagram illustrating conditional restrictions for eliminating interference in a range-Doppler frequency plane.

FIG. 9(A) is a diagram illustrating a first example of frequency and slow-time selectivity without a precoder.

FIG. 9(B) is a diagram illustrating a first example result of frequency and slow time selectivity with a precoder configured to maximize angular frequency and slow time flatness.

FIG. 9(C) is a diagram illustrating a first example result of frequency and slow time selectivity with a precoder configured to minimize capacity loss.

FIG. 10(A) is a diagram illustrating a second example of frequency and slow-time selectivity without a precoder.

FIG. 10(B) is a diagram illustrating a second example result of frequency and slow time selectivity with a precoder configured to maximize angular frequency and slow time flatness.

FIG. 10(C) is a diagram illustrating a second example result of frequency and slow time selectivity with a precoder configured to minimize capacity loss.

FIG. 11(A) is a diagram illustrating a third example of frequency and slow-time selectivity without a precoder.

FIG. 11(B) is a diagram illustrating a third example result of frequency and slow time selectivity with a precoder configured to maximize angular frequency and slow time flatness.

FIG. 11(C) is a diagram illustrating a third example result of frequency and slow time selectivity with a precoder configured to minimize capacity loss.

FIG. 12 is a flow chart of a process for minimizing the impact of frequency and time-domain cyclic shift-code on communication performance.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

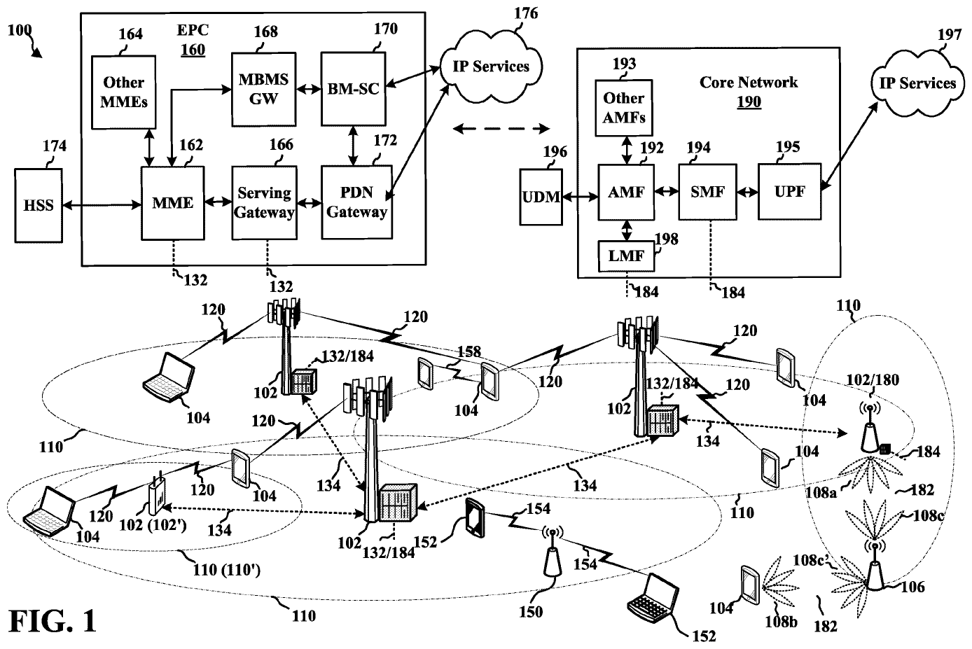

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

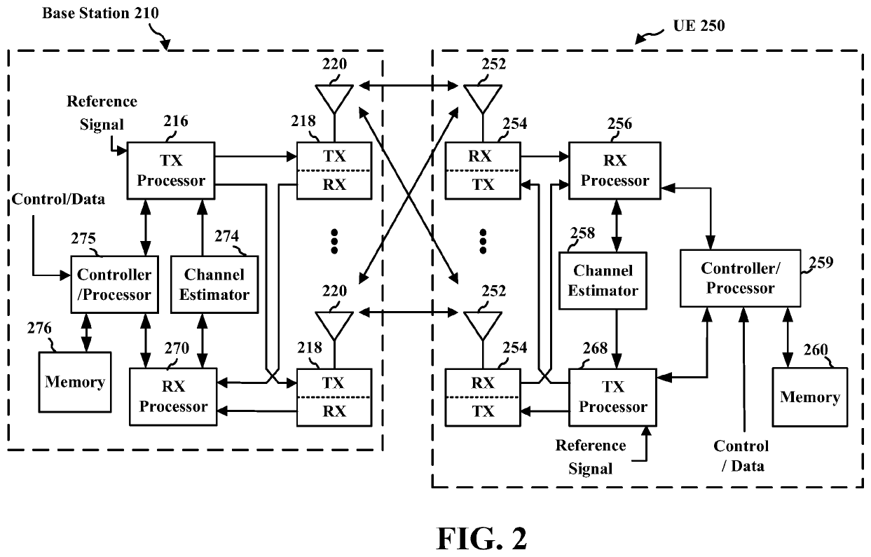

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

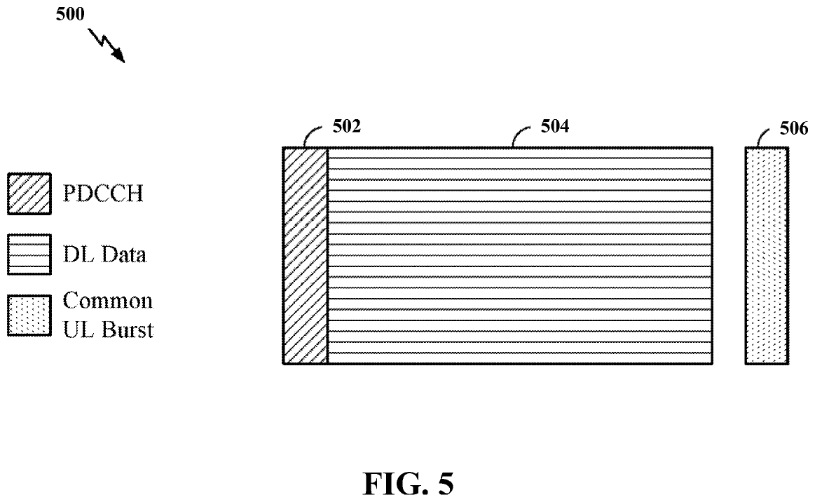

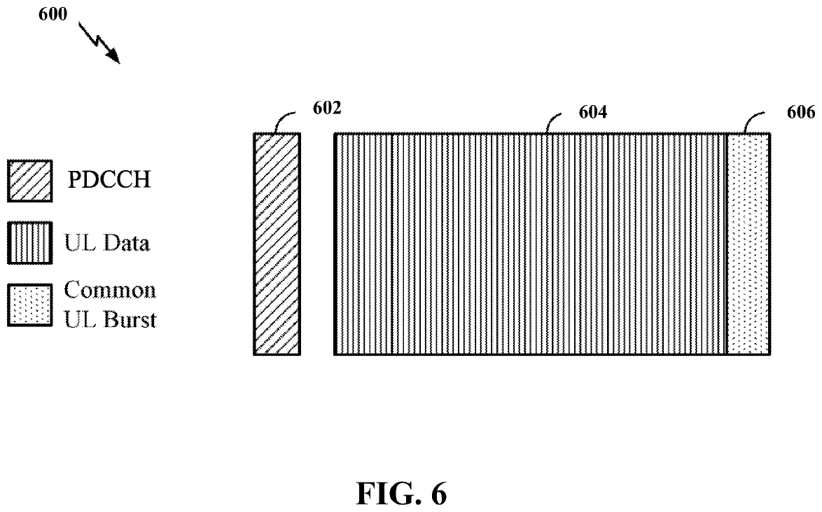

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

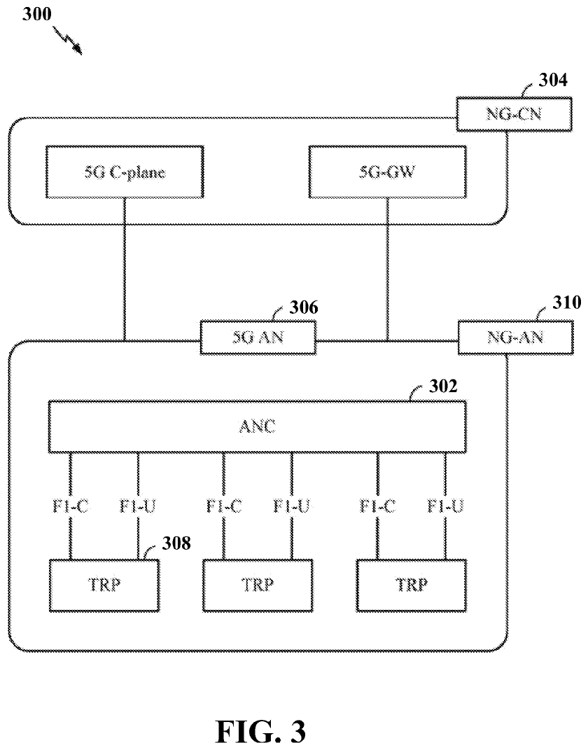

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

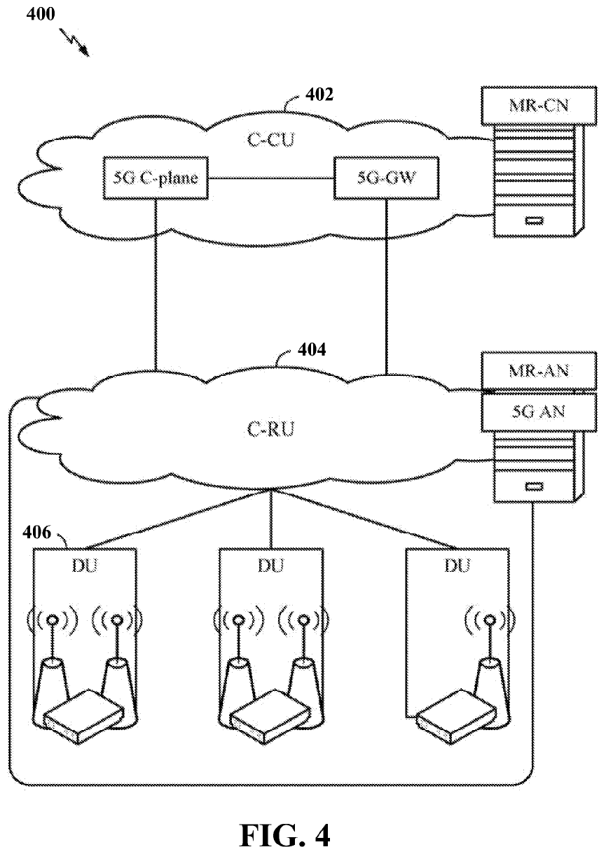

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

Integrated Sensing and Communication (ISAC), or communication-sensing integration, represents one of the pivotal technologies in the 6G era. It tightly integrates communication and sensing functionalities, aiming to enhance spectrum utilization efficiency, reduce equipment costs, and drive technological innovations across multiple domains.

In ISAC systems, sensing capabilities encompass target localization, imaging, detection, tracking, and identification, while communication is responsible for information transmission and aggregation. By directly integrating sensors and communication devices into the physical layer, ISAC facilitates a tight coupling between sensing and communication. This implies that devices can utilize sensors to acquire environmental information, which is then leveraged to adjust communication protocols and parameters, thereby maximizing network performance and stability.

Compared to traditional embedded sensing and communication technologies, ISAC systems provide deeper optimization capabilities for sensing and communication signals, improving the reliability and performance of wireless networks and providing real-time environmental sensing capabilities. Furthermore, as wireless communication frequency bands shift towards higher frequencies, communication-sensing integration emerges as a preferred solution to mitigate interference and enhance spectrum utilization. Consequently, ISAC systems can offer more efficient and intelligent solutions across various sectors.

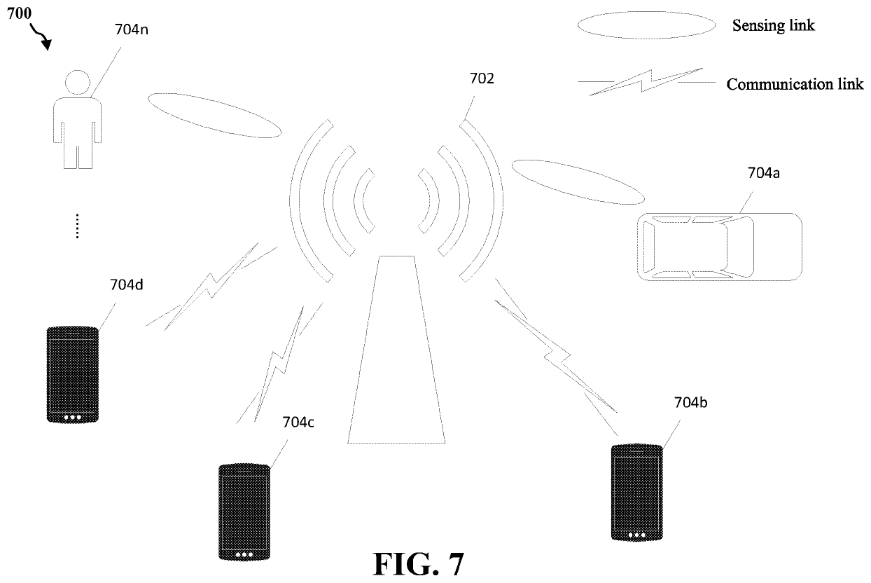

FIG. 7 is a diagram 700 illustrating an example architecture of an ISAC system. On the base station side of the ISAC system 700, a multi-antenna ISAC node 702 transmits a common OFDM signal (i.e., a unified OFDM waveform) to simultaneously estimate the parameters of the sensing target at the user side and communicate with a communication receiver that is located separately from the ISAC node 702.

In general, in the ISAC system 700, at the user side, there may be two types of objects. One of these is a sensing target (also known as a reflection target), such as objects 704a and 704n shown in FIG. 7. When the radar wave reaches the reflection target, it is reflected back, and the ISAC node 702 senses the direction of arrival (DoA), range, Doppler (velocity), and other parameters of the reflection target through the reflected wave (echo signal). The reflection target typically does not require transmitting and receiving functions.

Another object at the user side is a communication receiver (data receiving object), such as objects 704b-c shown in FIG. 7. In the ISAC system 700, the ISAC node 702 not only transmits radar waves but also carries communication data. The communication receiver is equipped with a communication receiving module to receive this communication data.

The above distinction is solely for the purpose of facilitating understanding and is not a strict limitation on the user-side objects 704a-n. The communication receiver can also reflect radar waves, and thus, it can be considered as a reflection target with data receiving capabilities.

At the base station side, the ISAC node 702, as a communication-sensing integration node, possesses both sensing and communication functions, primarily providing object sensing and communication services for terminals. Based on the type of antenna, the ISAC node 702 may exist in two forms: the collocated antenna form and the distributed antenna form. The primary distinction between these two forms is whether the azimuth angles of the transmitting and receiving ends are identical, although the performance achievable by both is equivalent. The following text will use the ISAC node 702 in the collocated antenna form as an illustrative example.

The transmitter (TX) and receiver (RX) of the collocated antenna ISAC node 702 (monostatic) are located in the same physical space but are physically separated to avoid signal interference. The transmitter and receiver can exchange information, allowing the receiver to understand the data information transmitted by the transmitter for use in radar data processing. In other words, the ISAC radar TX/RX and the communication RX can share the knowledge of the TX antenna port. In the present disclosure, it is assumed that the ISAC transmitter is equipped with M TX antennas and the radar receiver is equipped with L RX antennas. Furthermore, both the pilot signal and the payload signal can be utilized for the monostatic sensing capabilities of the ISAC radar RX.

The collocated ISAC transmitter and radar receiver of the ISAC node 702 form a 2D array, which can be used to estimate the 3D position parameters and velocity (Doppler) of potential targets.

The process of utilizing the same transmit antenna and signal for both radar and communication reception can be achieved by port diversity of the transmit antenna. Specifically, when the transmit antenna port of the MIMO radar receiving array in the link is combined with another receiver for data communication, the diversity of the transmit antenna ports can be leveraged to augment the size of the radar receiving virtual array, thereby enhancing resolution and parameter identification capabilities (i.e., the number of targets that can be estimated).

Since ISAC node 702 includes multiple antennas, it involves separating signals from different antennas. A frequency-domain cyclic shift-coded MIMO OFDM system can provide range division multiplexing, separating signals from multiple antennas in the range dimension, but this method shortens the maximum unambiguous range. Alternatively, cyclic shift coding can be implemented in the time domain. A time-domain cyclic shift-coded MIMO OFDM system can provide Doppler frequency division multiplexing, separating signals from multiple antennas in the Doppler dimension, but this reduces the maximum unambiguous Doppler frequency, limiting the maximum velocity that can be estimated.

Antenna signals can be separated through cyclic shifts in at least two dimensions: the time domain and the frequency domain. In other words, a hybrid approach that integrates time-domain and frequency-domain cyclic shift codes can be employed to achieve range-Doppler frequency division multiplexing. This approach allows for the separation of signals from different antennas within the range-Doppler plane.

This hybrid approach effectively addresses the limitations related to range and Doppler ambiguity issues by dynamically selecting an appropriate hybrid ratio between the two cyclic shift-based port diversity methods. It mitigates the loss due to range and Doppler ambiguity to a certain extent. By adjusting the hybrid ratio of cyclic shifts in both time and frequency domains, this hybrid approach maximizes the unambiguous range and Doppler (i.e., velocity). For a predefined hybrid ratio of cyclic shifts in the hybrid time-frequency domain, the cyclic shift in the time domain corresponds to a first hybrid ratio number, and the cyclic shift in the frequency domain corresponds to a second hybrid ratio number. The product of these two ratio numbers equals the number of transmit antennas in a transmit antenna set, such as the number of transmit antennas of the ISAC node 702 as shown in FIG. 7.

However, this hybrid approach may have some adverse effects on communication performance, particularly in terms of frequency and slow time selectivity. In some embodiments of the present disclosure, by appropriately designing a precoder for transmit port virtualization based on hybrid time-domain and frequency-domain cyclic shifts, the issues of frequency selectivity and slow time selectivity in the target communication receiver direction can be mitigated, ensuring minimal communication capacity loss in the intended direction of communication.

### Range-Doppler Domain Multiplexing

The range-Doppler domain multiplexing provided by the hybrid cyclic shift coded MIMO system can realize a 2D large virtual array for MIMO operation.

Assuming that the MIMO system has M transmit antennas and L receive antennas, the baseband CP-OFDM (Cyclic Prefix-OFDM) signal transmitted by the myth transmit antenna in the qth symbol is given by the following equation:

$${s}_{{m}_{t}}^{q} ( t ) = {\sum }_{k} {w}_{{m}_{t}}^{q} ( k ) {s}^{q} ( k ) exp ( j 2 π ( k - 1 ) Δ ft ) ξ ( t - ( q - 1 ) {T}_{s} ) , \qquad ( 1 )$$

$$t ∈ [ ( q - 1 ) {T}_{s} - {T}_{cp} , ( q - 1 ) {T}_{s} + T ]$$

$$ξ ( t ) = \{ \begin{matrix}1 , & t ∈ [ - {T}_{cp} , T ] \\ 0 , & otherwise\end{matrix}$$

where, t denotes the time t, with the initial time set to 0. mₜth denotes the myth transmit antenna. q and k denote the symbol index and the subcarrier index, respectively. In other words, considering q symbols, each symbol includes K orthogonal subcarriers.

$${w}_{{m}_{t}}^{q} ( k )$$

is the cover code for the hybrid time-domain and frequency-domain cyclic shift design. s^{q}(k) denotes the transmitted data on the kth subcarrier in the qth symbol. exp{ } denotes the exponential operator, j denotes the imaginary unit, and the subcarrier spacing is

$$Δ f = \frac{1}{T} .$$

T is the duration of the OFDM symbol part (OFDM main part) that does not contain the cyclic prefix. ξ(t) is a rectangular window function. The duration of each symbol is Tₛ=T+T_{cp}, and T_{cp} is the length of the cyclic prefix.

Consider the cyclic shifts in both the time domain and the frequency domain for each transmit antenna. Applying a phase rotation in the frequency domain (i.e., across the subcarrier index k) is equivalent to applying a cyclic shift in the range domain. Similarly, applying a phase rotation in the slow time domain (i.e., across the symbol index q) is equivalent to applying a cyclic shift in the Doppler frequency domain.

The hybrid cyclic shift code used to generate data fed to different transmit antennas is given by the following equation:

$${w}_{{m}_{t}}^{q} ( k ) = exp ( j 2 π \frac{{I}_{{m}_{t}}}{{M}_{T 1}} ( k - 1 ) ) exp ( j 2 π \frac{{J}_{{m}_{t}}}{{M}_{T 2}} ( q - 1 ) ) exp ( j {ϕ}_{{m}_{t}} ) \qquad ( 2 )$$

where, M_{T1}:M_{T2} is the hybrid ratio of the two port virtualization methods based on cyclic shift, M=M_{T1}M_{T2}.

Such a design is employed because adding a phase rotation in the frequency domain results in a cyclic shift in the time domain, e.g., a cyclic shift in the range dimension. Similarly, adding a phase rotation in the slow time domain, which means introducing a phase shift to each symbol, leads to a cyclic shift in the Doppler frequency. Based on this principle, a hybrid cyclic shift code that combines time domain and frequency domain shifts may be adopted. In Equation (2), the first exponential (exp) term represents a phase rotation in the frequency domain, while the second exp term represents a phase rotation in the slow time domain. During subsequent signal processing, the first exp term will cause a cyclic shift in range, and the second exp term will cause a cyclic shift in Doppler frequency. Additionally, the third exp term serves as a precoder, which essentially adds a distinct phase to each transmit antenna, representing the phase of the transmit antenna array.

For the first exp term, it represents a

$$\frac{{I}_{{m}_{t}}}{{M}_{T 1}}$$

phase rotation between two subcarriers (e.g., between k=1 and k=2), Iₘ_{ₜ}, has a different value for each transmit antenna. This results in each transmit antenna rotating at a different angle. Consequently, after performing the Fast Fourier Transformation (FFT), each unique rotation angle corresponds to a distinct displacement. In this way, the signals from different antennas can be distinguished in terms of range.

Similarly, for the second exp term, it represents a

$$\frac{{J}_{{m}_{t}}}{{M}_{T 2}}$$

phase rotation between two symbols, Jₘ_{ₜ} has a different value for each transmit antenna. This results in each transmit antenna rotating at a different angle. Consequently, after performing the FFT, each unique rotation angle corresponds to a distinct Doppler frequency. In this way, the signals from different antennas can be distinguished in terms of Doppler frequency.

Referring to Equation (2), phase rotations in both the frequency domain and time domain can be applied simultaneously. This operation involves the hybrid ratios of these two phase rotations, where M_{T1} and M_{T2} represent the frequency domain and time domain hybrid ratio numbers, respectively. For the sake of distinction, they can be referred to as the first and second hybrid ratio numbers, respectively; however, this numbering does not imply a specific order, and M_{T1} and M_{T2} can be interchangeably referred to as the second and first hybrid ratio numbers. In these hybrid ratio numbers, M_{T1} corresponds to dividing the frequency domain into M_{T1} parts (which, after signal processing, correspond to distinct ranges), and M_{T2} corresponds to dividing the slow time domain into M_{T2} parts (which, after signal processing, correspond to distinct Doppler frequencies, or velocities). Therefore, on the range-Doppler plane, this 2D structure can be divided into M=M_{T1}M_{T2} parts, where M is the total number of transmit antennas in the antenna set.

Define the index vector R as a permutation of a set [1, 2, . . . , M], a cyclic shift index matrix C=[0, 0; 0, 1; . . . ; 0, M_{T2}−1; . . . ; M_{T1}−1, 0; M_{T1}−1, 1; . . . ; M_{T1}−1, M_{T2}−1]. The first column of C is [0, 1, . . . , M_{T1}−1]^{T}⊗1_{M}_{_{T2}}_{×1}, and the second column of C is 1_{M}_{_{T1×1}}⊗[0, 1, . . . , M_{T2}−1]^{T}. (Iₘ_{ₜ}, Jₘ_{ₜ}) is the Rₘ_{ₜ}th row of C, where Rₘ_{ₜ} is the mₜth element of R. This matrix gives possible choices of Iₘ_{ₜ} and Jₘ_{ₜ}, and each selection selects an element from the matrix, which is a non-repeated selection process. For example, the first element of the matrix is 00, that is, Iₘ_{ₜ} and Jₘ_{ₜ} are 0 respectively, and then Iₘ_{ₜ} can remain unchanged, changing Jₘ_{ₜ} from 1 to M_{T2}−1 successively; then, Iₘ_{ₜ} can change from 1 to M_{T1}−1 successively, and for each Iₘ_{ₜ}, Jₘ_{ₜ} change from 1 to M_{T2}−1 successively; and so on, the last element of the matrix is M_{T1}−1, M_{T2}−1, a total of M_{T1}M_{T2} cyclic shifts are achieved, thereby separating the M transmit antennas. In the above selection process, the selection order of Iₘ_{ₜ} and Jₘ_{ₜ} can also be exchanged, that is, Jₘ_{ₜ} can also be kept unchanged first, and then Iₘ_{ₜ} changes in sequence to perform selection.

Let

$$( {x}_{{m}_{t}}^{T} , {0}_{{m}_{t}}^{T} , {y}_{{m}_{t}}^{T} )$$

be the location of the mₜth TX, and

$$( {x}_{{m}_{r}}^{R} , {0}_{{m}_{r}}^{R} , {y}_{{m}_{r}}^{R} )$$

be the location of the mᵣth RX. Assume that there are N targets and the delay, Doppler frequency, azimuth angle, elevation angle, and complex gain of the nth target are τₙ, fₙ, θₙ, ψₙ, Ãₙ respectively. After down-conversion, the baseband echo received by the radar receiver (i.e., the sensing waveform after the hybrid cover code is applied) is given by:

$$\tilde{y} ( t ) = \sqrt{ML} {\sum }_{n} {\sum }_{q} {\tilde{A}}_{n} exp ( j 2 π {f}_{n} {T}_{s} ( q - 1 ) ) {a}^{R} ( {θ}_{n} , {ψ}_{n} ) {a}^{T} ( {θ}_{n} , {ψ}_{n} ) {x}^{q} ( t - {τ}_{n} ) \qquad ( 3 )$$

$${a}^{R} ( θ , ψ ) = {\frac{1}{\sqrt{L}} [ exp ( - \frac{j 2 π}{λ} ( {x}_{1}^{R} cos θ cos ψ + {z}_{1}^{R} sin ψ ) ) , … , exp ( - \frac{j 2 π}{λ} ( {x}_{L}^{R} cos θ cos ψ + {z}_{L}^{R} sin ψ ) ) ]}^{T} \qquad ( 4 )$$

$${a}^{T} ( θ , ψ ) = {\frac{1}{\sqrt{M}} [ exp ( - \frac{j 2 π}{λ} ( {x}_{1}^{T} cos θ cos ψ + {z}_{1}^{T} sin ψ ) ) , … , exp ( - \frac{j 2 π}{λ} ( {x}_{M}^{T} cos θ cos ψ + {z}_{M}^{T} sin ψ ) ) ]}^{T} \qquad ( 5 )$$

In Equations (4) and (5), a_{R}(θ, ψ) and a^{T}(θ, ψ) are the steering vectors corresponding to the receiver array and the transmitter array, respectively.

Assume that for any n, τₙ≤T_{cp}. For the echo signal in Equation (3), after CP removal, OFDM defaming and demodulation to remove the randomness induced by the payload, i.e., s^{q}(k) in Equation (1), the preprocessed echo is:

$${{y}^{︶}}^{q} ( k ) = \sqrt{L} {\sum }_{n} {A}_{n} exp ( j 2 {πf}_{n} {T}_{s} ( q - 1 ) ) exp ( - j 2 π ( k - 1 ) Δ f {τ}_{n} ) {a}^{R} ( {β}_{n} , {α}_{n} ) {Σ}_{{m}_{t}} exp ( - \frac{j 2 π}{λ} ( {x}_{{m}_{t}}^{T} cos θ cos ψ + {z}_{{m}_{t}}^{T} sin ψ ) ) {w}_{{m}_{t}}^{q} ( k ) \qquad ( 6 )$$

In order to recover the data from the mₜth TX and the mᵣth RX, the waveform obtained in Equation (6) can be multiplied by the complex conjugate of the cover code corresponding to the mₜth TX to obtain this signal

$${z}_{{m}_{t} , {m}_{r}}^{q} ( k ) \cdot {z}_{{m}_{t} , {m}_{r}}^{q} ( k )$$

is composed of the desired echo from the mₜth TX and the mᵣth RX (i.e., the first addition term in Equation (7) below) and interference from other transmit antennas (i.e., the second addition term in Equation (7) below). In Equation (7), conj(⋅) denotes a function for calculating the complex conjugate value.

$${z}_{{m}_{t} , {m}_{r}}^{q} ( k ) = conj ( {z}_{{m}_{t}}^{q} ( k ) ) {{y}^{︶}}_{{m}_{r}}^{q} ( k ) = {z}_{{m}_{t} , {m}_{r}}^{q , desired} ( k ) + {z}_{{m}_{t} , {m}_{r}}^{q , interference} ( k ) \qquad ( 7 )$$

$${z}_{{m}_{t} , {m}_{r}}^{q , desired} ( k ) = {Σ}_{n} {A}_{n} exp ( - \frac{j 2 π}{λ} ( {x}_{{m}_{r}}^{R} cos θ cos ψ + {z}_{{m}_{r}}^{R} sin ψ ) ) exp ( - j 2 π ( k - 1 ) Δ f {τ}_{n} ) exp ( - \frac{j 2 π}{λ} ( {x}_{{m}_{t}}^{T} cos θ cos ψ + {z}_{{m}_{t}}^{T} sin ψ ) ) exp ( j2 π {f}_{n} {T}_{s} ( q - 1 ) ) \qquad ( 8 )$$

$${z}_{{m}_{t} , {m}_{r}}^{q , interference} ( k ) = {Σ}_{n} {A}_{n} exp ( - \frac{j 2 π}{λ} ( {x}_{{m}_{r}}^{R} cos θ cos ψ + {z}_{{m}_{r}}^{R} sin ψ ) ) {\sum }_{{m}_{t}^{′} \neq {m}_{t}} exp ( - \frac{j 2 π}{λ} ( {x}_{{m}_{t}^{′}}^{T} cos θ cos ψ + {z}_{{m}_{t}^{′}}^{T} sin ψ ) ) exp ( - j 2 π ( k - 1 ) Δ f {τ}_{n} - \frac{{I}_{{m}_{t}^{′}} - {I}_{{m}_{t}}}{{M}_{T 1}} ) ) exp ( j2 π ( q - 1 ) ( {f}_{n} {T}_{s} + \frac{{J}_{{mt}^{′}} - {I}_{mt}}{{M}_{T2}} ) ) \qquad ( 9 )$$

Equations (8) and (9) show that the desired echo and the interference can be distinguished based on Doppler frequency and delay by applying 2D FFT on

$${z}_{{m}_{t} , {m}_{r}}^{q} ( k ) .$$

Specifically, by comparing the second exp term exp(−j2π(k−1)Δfτₙ) in Equation (8) with the third exp term

$$exp ( - j 2 π ( k - 1 ) ( Δ f {τ}_{n} - \frac{{I}_{{m}_{t}^{′}} - {I}_{{m}_{t}}}{{M}_{T 1}} ) )$$

in Equation (9), in terms of delay, the interference is shifted by

$$\frac{{I}_{{m}_{t}^{′}} - {I}_{{m}_{t}}}{{M}_{T 1}}$$

relative to the desired echo. Similarly, by comparing the fourth exp term exp(j2πfₙ Tₛ(q−1)) in Equation (8) with the fourth exp term

$$exp ( j 2 π ( q - 1 ) ( {f}_{n} {T}_{s} + \frac{{J}_{{mt}^{′}} - {J}_{mt}}{{M}_{T 2}} )$$

in Equation (9), in terms of Doppler frequency, the interference is also shifted by

$$\frac{{J}_{{mt}^{′}} - {J}_{mt}}{{M}_{T 2}}$$

relative to the desired echo.

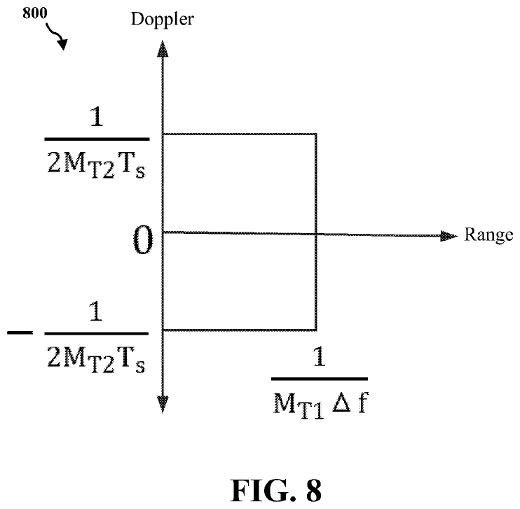

FIG. 8 is a diagram 800 illustrating conditional restrictions for eliminating interference in a range-Doppler frequency plane. Since MIMO with cyclic shift coding in both the frequency domain and time domain provide range-Doppler multiplexing, interference can be eliminated by only keeping the data satisfying two conditions: time delay

$${τ}_{n} ∈ [ 0 , \frac{1}{{M}_{T 1} Δ f} ]$$

and Doppler frequency

$${f}_{n} ∈ [ - \frac{1}{2 {M}_{T 2} {T}_{S}} , \frac{1}{2 {M}_{T 2} {T}_{S}} ] .$$

These two conditions are equivalent to forming a square in the range-Doppler frequency plane, as shown in FIG. 8. The information within this square represents the desired ideal information, while the information at other positions corresponds to interference. Therefore, the data in the square can be retained, while the rest of the data (i.e., the data outside the square) is set to zero.

Thus, the maximum unambiguous time delay min

$$( {T}_{cp} , \frac{1}{{M}_{{T}_{1}} Δ f} )$$

is obtained, and the maximum unambiguous range is

$$\frac{c}{2} min ( {T}_{cp} , \frac{1}{{M}_{T 1} Δ f} ) ,$$

where c is the light speed. Similarly, the maximum unambiguous Doppler frequency is

$$\vert \frac{1}{2 {M}_{T 2} {T}_{S}} \vert .$$

If only the cyclic shift code on frequency is considered, the maximum unambiguous range becomes 1/M. If only the cyclic shift code on slow time is considered, the maximum unambiguous velocity becomes 1/M. By splitting M into M=M_{T1}M_{T2} appropriately, the maximum unambiguous range can be adjusted to 1/M_{T1}, and similarly, the maximum unambiguous velocity can be adjusted to 1/M_{T2}. The hybrid cyclic shift code may effectively mitigate the limitations associated with range and Doppler ambiguity problems by adaptively selecting the suitable hybrid ratio between the two cyclic shift-based port diversity methods.

### Impact of Hybrid Cyclic Shift Codes in Time-Frequency Domain on Communication Performance

Consider a uniform linear transmit (TX) array with M elements that are shared for both sensing and communication, along with a communication receiver equipped with receive antennas. Let

$$( 0 , 0 , \frac{λ}{2} ( {m}_{t} - 1 ) )$$

be the location of the myth TX antenna. For the TX angle of departure (AOD), the angular domain channel pattern at the kth subcarrier of the qth symbol is

$${H}_{ϑ} ( k , q ) = {\sum }_{{m}_{t} = 1}^{M} exp ( - j π ( {m}_{t} - 1 ) sin ϑ ) exp ( j 2 π ( \frac{{I}_{{m}_{t}}}{{M}_{T 1}} ( k - 1 ) + \frac{{J}_{{m}_{t}}}{{M}_{T 2}} ( q - 1 ) ) + j {ϕ}_{mt} ) \qquad ( 01 )$$

where

$$exp ( j 2 π ( \frac{{I}_{{m}_{t}}}{{M}_{T 1}} ( k - 1 ) + \frac{{J}_{{m}_{t}}}{{M}_{T 2}} ( q - 1 ) ) + j {ϕ}_{mt} )$$

corresponds to

$${w}_{{m}_{t}}^{q} ( k )$$

in Equation (2), H_{ϑ}(k, q) is a Periodic function, where H_{ϑ}(k, q)=H_{ϑ}(k, q+M_{T2}), and H_{ϑ}(k+M_{T1}, q)=H_{ϑ}(k,q)

In the direction of the communication receiver, frequency selectivity and slow time selectivity can be observed. That is, the addition of the above M items may result in the addition of all carriers to become M or 0. If a hybrid cyclic-shift-based port virtualization using cyclic shift delay only considers 1-dimensional array port virtualization, it will not address the angular- and spectral-domain selectivity issues, resulting in a degradation in the performance of the communication system.

Precoder design, i.e., jφₘₜ, is used to solve the problems of frequency selectivity and slow time selectivity. The design indicators include angular frequency and slow time flatness, as denoted by the equation below.

$$Angular frequency and slow time flatness = \frac{{min}_{k , q} \vert {H}_{ϑ} ( k , q ) \vert}{- {max}_{k , q} \vert {H}_{ϑ} ( k , q ) \vert} \qquad ( 11 )$$

That is, angular frequency and slow time flatness are equal to the ratio of the minimum to maximum absolute value of H_{ϑ} of a given specific communication angle ϑ on different subcarriers and different symbols. When the ratio is equal to 1, it means that the amplitude of H_{ϑ} on different subcarriers and different symbols is the same. In addition, according to the properties of cyclic shift, H_{ϑ}(k, q) is a periodic function in both subcarrier and symbol dimensions, and its period on symbol is M_{T2}, and its period on subcarrier is M_{T1}.

In some embodiments of the precoder design, the direction corresponding to minimizing capacity loss or maximizing angular frequency and slow-time flatness can be steered to the direction of the target communication by appropriately choosing {Iₘ_{ₜ}, Jₘ_{ₜ}} and {φₘ_{ₜ}}. In other words, there are two approaches to designing the precoder. The first approach is to minimize the capacity loss in a specific direction. The second approach is to maximize the angular frequency and slow-time flatness in that direction, ideally achieving a flatness value of 1. The result achieved through maximizing angular frequency and slow-time flatness aligns with that obtained by minimizing capacity loss.

Consider the following example: assume a uniform linear transmit (TX) array with M_{T}=4 elements located at

$$( 0 , 0 , \frac{λ}{2} ( {m}_{t} - 1 ) ) ,$$

where mₜ=1, . . . , 4. Let the hybrid ratio be M_{T1}:M_{T2}=2:2. That is, it is divided into two parts in both the time domain and the frequency domain, meaning that the first and second hybrid ratios are equal. The direction (AOD) of the communication receiver ϑ=0.

$${H}_{ϑ} ( k , q ) = {\sum }_{{m}_{t}} exp ( - j πsin ϑ ( {m}_{t} - 1 ) ) exp ( j 2 π ( \frac{{I}_{{m}_{t}}}{{M}_{T 1}} ( k - 1 ) + \frac{{J}_{{m}_{t}}}{{M}_{T 2}} ( q - 1 ) ) + j {ϕ}_{mt} ) \qquad ( 12 )$$

Through the design of the precoder, the impact of frequency domain and time domain cyclic shift codes on communication performance can be minimized. Consequently, the following results were obtained.

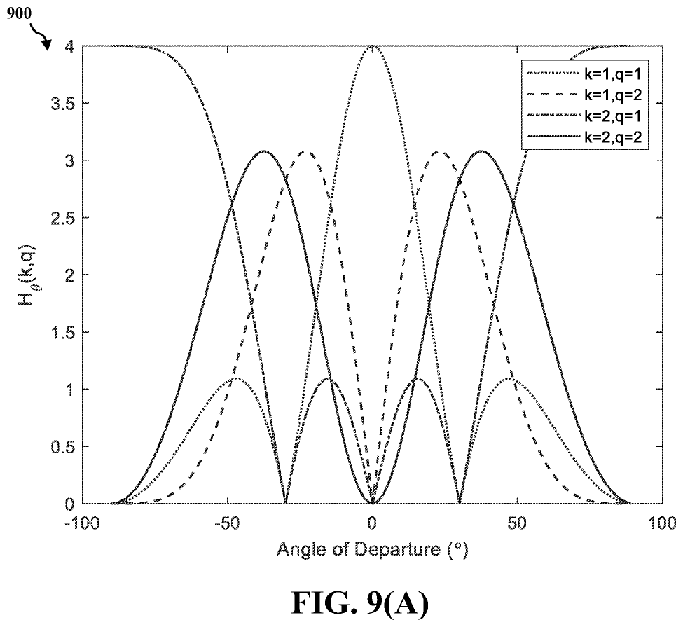

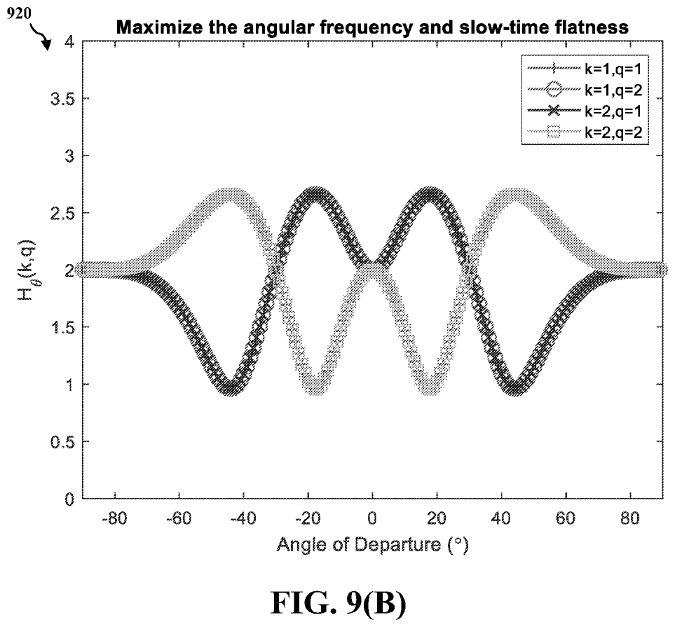

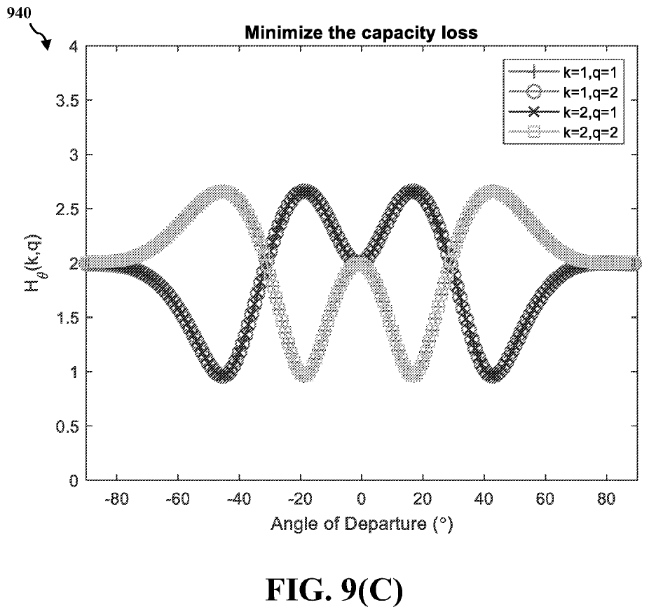

FIG. 9(A) is a diagram 900 illustrating a first example of frequency and slow-time selectivity without a precoder. For the cyclic shift index vectors I and J, in the example shown in FIG. 9(A), I=[0, 1, 0, 1] and J=[0, 0, 1, 1] are chosen. If no precoder is added, that is, for mₜ=0, φₘₜ=0. At an angle of 0 degrees, only when k is equal to 1 and q is equal to 1, the signal from different TXs are constructively added, resulting in a value of 4, and in the three cases of 1) k is equal to 1, q is equal to 2, 2) k is equal to 2, q is equal to 1, 3) k is equal to 2, q is equal to 2, the value is 0. This indicates that at the same angle, the channel response H_{ϑ}(k, q) from different subcarriers and from different symbols has a significant difference. This difference has different forms at different angles. For example, at an angle of negative 30 degrees, in the above four cases, two values are 0 and two values are between 2.5-3. This phenomenon is called selectivity in frequency and slow time.

FIG. 9(B) is a diagram 920 illustrating a first example result of frequency and slow time selectivity with a precoder configured to maximize angular frequency and slow time flatness. FIG. 9(C) is a diagram 940 illustrating a first example result of frequency and slow time selectivity with a precoder configured to minimize capacity loss. FIGS. 9(B) and 9(C) illustrate the results after adding the precoder. As shown in FIGS. 9(B) and 9(C), regardless of whether the method of maximizing angular frequency and slow time flatness or the method of minimizing capacity loss is adopted, at the desired communication position, that is, at an angle of 0 degrees, the values H_{ϑ}(k, q) from different subcarriers and from different symbols all take the same value, namely, 2.

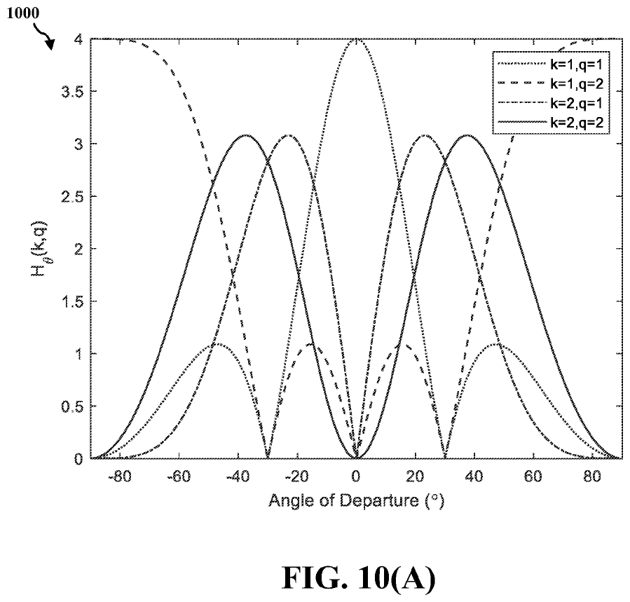

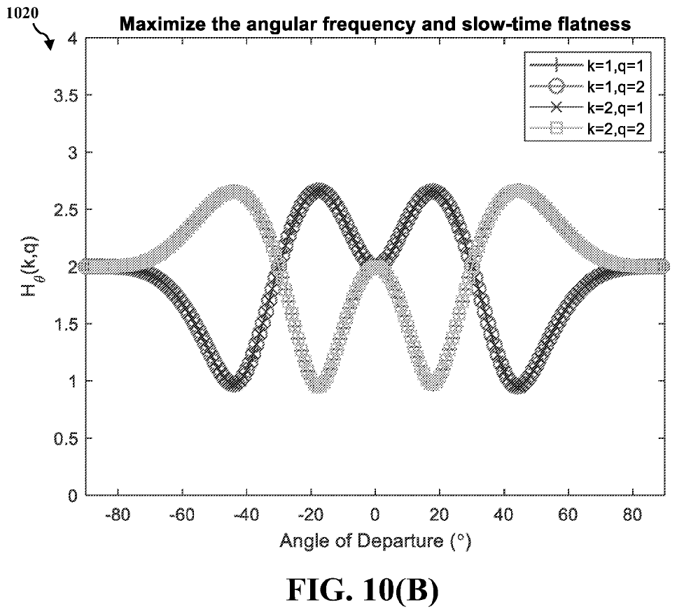

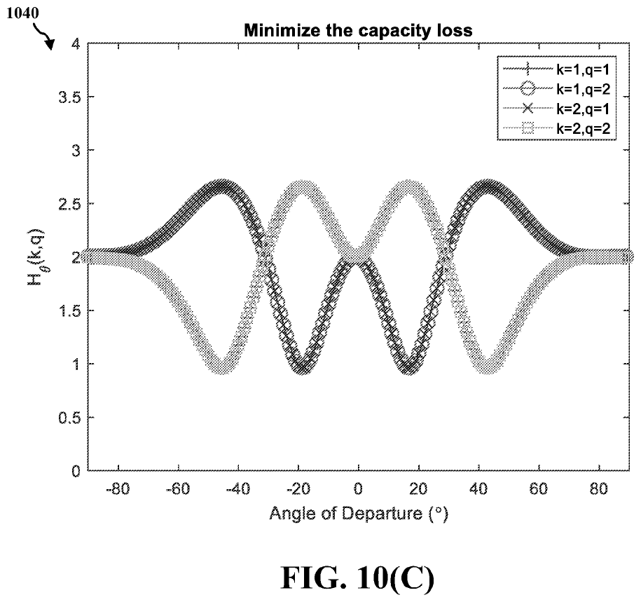

FIG. 10(A) is a diagram 1000 illustrating a second example of frequency and slow-time selectivity without a precoder. FIG. 10(B) is a diagram 1020 illustrating a second example result of frequency and slow time selectivity with a precoder configured to maximize angular frequency and slow time flatness. FIG. 10(C) is a diagram 1040 illustrating a second example result of frequency and slow time selectivity with a precoder configured to minimize capacity loss. For the example shown in FIGS. 10(A)-(C), I=[0, 0, 1, 1] and J=[0, 1, 0, 1] are chosen. Without the addition of the precoder, at the position where the Angle of Departure (AOD) is 0, the value is 4 only when k equals 1 and q equals 1; in the other three cases, all H_{ϑ}(k, q) is 0. However, after incorporating the precoder, at the desired position, for all subcarriers and symbols, H_{ϑ}(k, q) are uniformly 2.

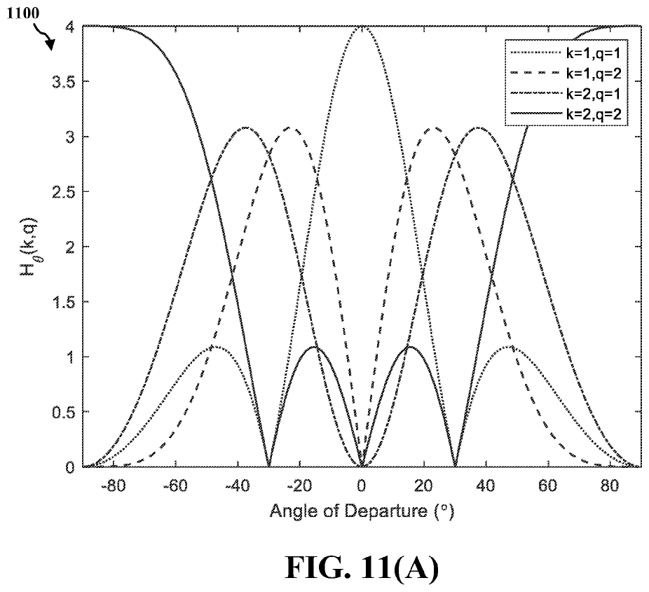

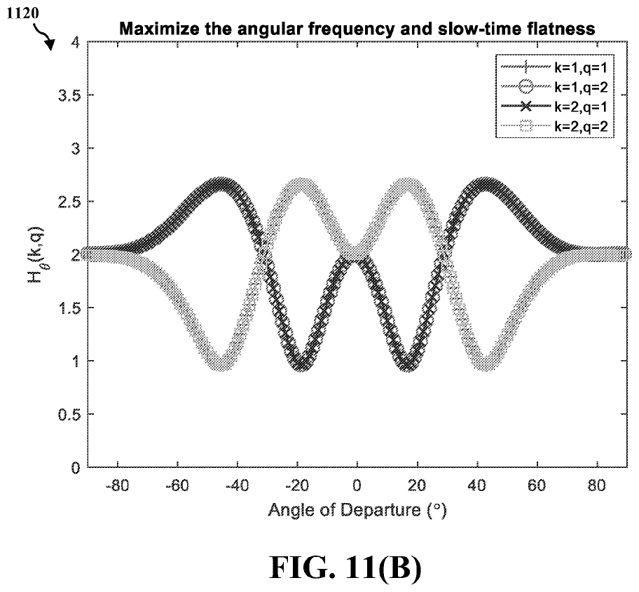

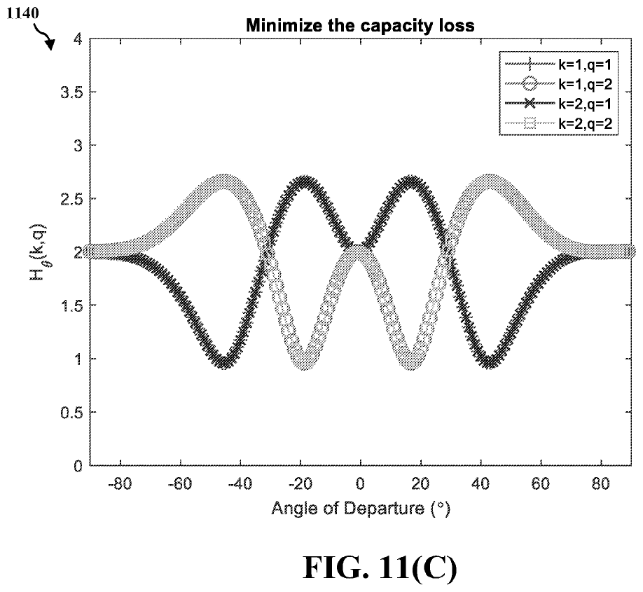

FIG. 11(A) is a diagram 1100 illustrating a third example of frequency and slow-time selectivity without a precoder. FIG. 11(B) is a diagram 1120 illustrating a third example result of frequency and slow time selectivity with a precoder configured to maximize angular frequency and slow time flatness. FIG. 11(C) is a diagram 1140 illustrating a third example result of frequency and slow time selectivity with a precoder configured to minimize capacity loss. For the example shown in FIGS. 11(A)-(C), where I=[0, 1, 1, 0] and J=[0, 0, 1, 1] are chosen, that similar conclusions are drawn as in the examples shown in FIGS. 9(A)-9(C) and 10(A)-10(C).

In the communication-sensing integration system, hybrid time-domain and frequency-domain cyclic shift coding port virtualization enhances azimuth resolution by forming a large virtual MIMO array. However, this approach introduces frequency selectivity and slow time selectivity problems in the direction of the communication receiver. The present disclosure addresses these issues by appropriately designing a precoder on top of hybrid time-domain and frequency-domain cyclic shift for transmit port virtualization.

The present disclosure introduces a precoder design for minimizing the impact of hybrid time and frequency-domain cyclic shift-coded port virtualization on communication performance. This design aims to either 1) minimize capacity loss or 2) maximize angular frequency and slow time flatness in the direction of the target communication receiver. Such a design is particularly suitable for providing 3-D sensing information (i.e., obtaining three-dimensional position information of the target) using a 2-D MIMO array, while maintaining communication performance by minimizing the loss caused by factors such as frequency selectivity in the communication direction. Furthermore, the cyclic shift brings built-in spatial diversity.

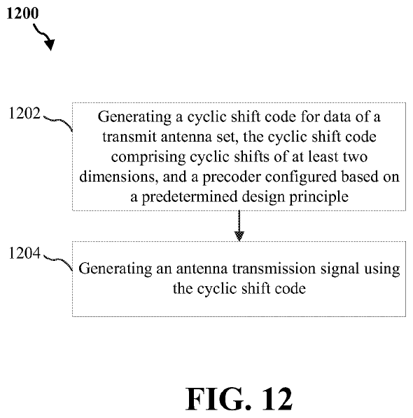

FIG. 12 is a flow chart 1200 of a process for minimizing the impact of frequency and time-domain cyclic shift-code on communication performance. This process may be performed on a network side (e.g., the base station 702) or a UE (e.g., the UE 704).

At block 1202, the process may generate a cyclic shift code for data of a transmit antenna set. The cyclic shift code may include cyclic shifts of at least two dimensions, and a precoder configured based on a predetermined design principle.

Following the generation of the cyclic shift code, at block 1204, the process may generate an antenna transmission signal using the cyclic shift code.

In some embodiments, the predetermined design principle may include: configuring the precoder so that a direction of the antenna transmission signal, corresponding to minimizing capacity loss, is steered to a communication receiver direction.

In some embodiments, the predetermined design principle may include: configuring the precoder so that a direction of the antenna transmission signal, corresponding to maximizing frequency and slow time flatness in angular domain, is steered to a communication receiver direction.

In some embodiments, the cyclic shifts of at least two dimensions may include cyclic shifts in time domain and frequency domain.

In some embodiments, the cyclic shifts in the time domain and the frequency domain may be mixed at a predetermined hybrid ratio, the cyclic shift in the time domain may correspond to a first hybrid ratio number, the cyclic shift in the frequency domain may correspond to a second hybrid ratio number, and the product of the first hybrid ratio number and the second hybrid ratio number may correspond to the number of antennas in the transmit antenna set.

In some embodiments, the first hybrid ratio number and the second hybrid ratio number may be equal.

In some embodiments, the process may be performed in an integrated sensing and communication (ISAC) system with the antenna transmission signal for sensing, and the transmit antenna may include a multiple-input multiple-output (MIMO) antenna system.

In some embodiments, the ISAC system may include a two-dimensional (2D) array composed of collocated ISAC transmitters and radar receivers.

In some embodiments, the antenna transmission signal may be a baseband cyclic prefix orthogonal frequency division multiplexing (CP-OFDM) signal.

The specific order or hierarchy of blocks in the processes/flowcharts disclosed is an illustration of exemplary approaches. Based upon design preferences, the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication, comprising:
generating a cyclic shift code for data of a transmit antenna set, the cyclic shift code comprising cyclic shifts of at least two dimensions, and a precoder configured based on a predetermined design principle; and
generating an antenna transmission signal using the cyclic shift code.

2. The method according to claim 1, wherein the predetermined design principle comprises: configuring the precoder so that a direction of the antenna transmission signal, corresponding to minimizing capacity loss, is steered to a communication receiver direction.

3. The method according to claim 1, wherein the predetermined design principle comprises: configuring the precoder so that a direction of the antenna transmission signal, corresponding to maximizing frequency and slow time flatness in angular domain, is steered to a communication receiver direction.

4. The method according to claim 1, wherein the cyclic shifts of at least two dimensions comprise cyclic shifts in time domain and frequency domain.

5. The method according to claim 4, wherein the cyclic shifts in the time domain and the frequency domain are mixed at a predetermined hybrid ratio, the cyclic shift in the time domain corresponds to a first hybrid ratio number, the cyclic shift in the frequency domain corresponds to a second hybrid ratio number, and the product of the first hybrid ratio number and the second hybrid ratio number corresponds to the number of antennas in the transmit antenna set.

6. The method according to claim 5, wherein the first hybrid ratio number and the second hybrid ratio number are equal.

7. The method according to claim 5, wherein the method is performed in an integrated sensing and communication (ISAC) system with the antenna transmission signal for sensing, and the transmit antenna includes a multiple-input multiple-output (MIMO) antenna system.

8. The method according to claim 7, wherein the ISAC system comprises a two-dimensional (2D) array composed of collocated ISAC transmitters and radar receivers.

9. The method according to claim 1, wherein the antenna transmission signal is a baseband cyclic prefix orthogonal frequency division multiplexing (CP-OFDM) signal.

10. An apparatus for wireless communication, comprising:
a memory; and
at least one processor coupled to the memory and configured to:
generate a cyclic shift code for data of a transmit antenna set, the cyclic shift code comprising cyclic shifts of at least two dimensions, and a precoder configured based on a predetermined design principle; and
generate an antenna transmission signal using the cyclic shift code.

11. The apparatus according to claim 10, wherein the predetermined design principle comprises: configuring the precoder so that a direction of the antenna transmission signal, corresponding to minimizing capacity loss, is steered to a communication receiver direction.

12. The apparatus according to claim 10, wherein the predetermined design principle comprises: configuring the precoder so that a direction of the antenna transmission signal, corresponding to maximizing frequency and slow time flatness in angular domain, is steered to a communication receiver direction.

13. The apparatus according to claim 10, wherein the cyclic shifts of at least two dimensions comprise cyclic shifts in time domain and frequency domain.

14. The apparatus according to claim 13, wherein the cyclic shifts in the time domain and the frequency domain are mixed at a predetermined hybrid ratio, the cyclic shift in the time domain corresponds to a first hybrid ratio number, the cyclic shift in the frequency domain corresponds to a second hybrid ratio number, and the product of the first hybrid ratio number and the second hybrid ratio number corresponds to the number of antennas in the transmit antenna set.

15. The apparatus according to claim 14, wherein the first hybrid ratio number and the second hybrid ratio number are equal.

16. The apparatus according to claim 14, wherein the apparatus operates in an integrated sensing and communication (ISAC) system with the antenna transmission signal for sensing, and the transmit antenna includes a multiple-input multiple-output (MIMO) antenna system.

17. The apparatus according to claim 16, wherein the ISAC system comprises a two-dimensional (2D) array composed of collocated ISAC transmitters and radar receivers.

18. The apparatus according to claim 10, wherein the antenna transmission signal is a baseband cyclic prefix orthogonal frequency division multiplexing (CP-OFDM) signal.

19. A computer-readable medium storing computer executable code for wireless communication, comprising code to:
generate a cyclic shift code for data of a transmit antenna set, the cyclic shift code comprising cyclic shifts of at least two dimensions, and a precoder configured based on a predetermined design principle; and
generate an antenna transmission signal using the cyclic shift code.

20. The computer-readable medium according to claim 19, wherein the cyclic shifts of at least two dimensions comprise cyclic shifts in time domain and frequency domain; and
wherein the cyclic shifts in the time domain and the frequency domain are mixed at a predetermined hybrid ratio, the cyclic shift in the time domain corresponds to a first hybrid ratio number, the cyclic shift in the frequency domain corresponds to a second hybrid ratio number, and the product of the first hybrid ratio number and the second hybrid ratio number corresponds to the number of antennas in the transmit antenna set.
